(19) United States
(12) Patent Application Publication
(10) Pub. No.: US 2006/0092813 A1
(43) Pub. Date: May 4, 2006

(54) Optical pickup apparatus and method of combining submount and optical bench of the same

(75) Inventors: Sung-dong Suh, Seoul (KR); Jin-seung Sohn, Seoul (KR); Eun-hyoung Cho, Seoul (KR); Young-soo Jin, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRO-MECHANICS CO., LTD.

(21) Appl. No.: 11/256,155

(22) Filed: Oct. 24, 2005

(30) Foreign Application Priority Data
Nov. 3, 2004 (KR) 10-2004-0088868

(51) Int. Cl. G11B 7/00

(52) U.S. Cl. 369/112.01

(57) ABSTRACT

An optical pickup apparatus and a method of combining a submount and an optical bench of the optical pickup apparatus are provided. The optical pickup apparatus includes an optical bench, a submount installed on the optical bench, a light source mounted on the submount, a lens unit joined to the optical bench, and an optical path separator which separates light that is emitted from the light source and then proceeds to the lens unit from light that is incident from the lens unit, wherein the submount is soldered to the optical bench.

### BACKGROUND OF THE INVENTION

This application claims priority from Korean Patent Application No. 10-2004-0088868, filed on Nov. 3, 2004, in the Korean Intellectual Property Office, the disclosure of which is incorporated herein in its entirety by reference.

1. Field of the Invention

The present invention relates to an optical pickup apparatus, and more particularly, to an optical pickup apparatus and a method of combining a submount and an optical bench of the optical pickup apparatus.

2. Description of the Related Art

Generally, an optical pickup apparatus is used in an optical recording/reproducing apparatus such as a compact disc (CD) player, a CD-ROM, a digital versatile disc (DVD) player, a DVD-ROM, or a blue-ray disc (BD)-ROM to record/reproduce information in a non-contact manner with respect to a disc. Recently, with the wide use of optical recording/reproducing apparatuses in personal digital assistants (PDAs), portable MPEG-1, Layer 3 (MP3) players, portable CD players, etc., an optical pickup apparatus for a small, thin recording/reproducing apparatus supporting high-density media is required.

A conventional optical pickup apparatus includes a light source, a submount, a silicon optical bench (SiOB), a photodetector, and a lens unit. A laser diode (LD) chip is usually used as the light source.

In an optical pickup apparatus, positions of optical elements are determined according to the design of an optical path. Alignment and bonding of the optical elements on the optical path exert a great influence on the precision and reproducibility of the optical pickup apparatus.

Conventionally, the submount is used to discharge heat radiated from the LD chip and position the LD chip on the optical path. In such a conventional optical pickup apparatus, the submount is disposed on the SiOB and the LD chip is mounted on the submount. Since the LD chip is positioned at one side of a top surface of the submount, the center of gravity of the LD chip does not coincide with that of the submount. Accordingly, the center of gravity of the submount having the LD chip inclines toward the side where the LD chip is mounted.

Conventionally, the submount having the LD chip is bonded to the SiOB using an epoxy resin, for example, Ag-epoxy. During the bonding, the epoxy resin is soft and the center of gravity of the submount having the LD chip is inclined. Accordingly, the thickness of the epoxy resin is not maintained uniform during hardening. As a result, the submount and the LD chip become oblique to the SiOB, and therefore, light emitted from the LD chip does not proceed perpendicularly to a surface of the LD chip from which the light is output. Instead, the light emitted from the LD chip proceeds obliquely, causing misalignment in optical elements. To reduce such misalignment, processes of adjusting a lens or the like through which the light from the LD chip passes to slant as much as the LD chip slants and fixing the slanted position are performed. However, these additional processes cause manufacturing cost and time to be increased.

### SUMMARY OF THE INVENTION

The present invention provides an optical pickup apparatus and a method of combining a submount and an optical bench of the optical pickup apparatus, by which a combination relationship between the submount and the optical bench is improved such that light emitted from a light source proceeds along an optical path, which is formed by optical elements, without adjustment of the optical elements.

According to an aspect of the present invention, there is provided an optical pickup apparatus including an optical bench, a submount installed on the optical bench, a light source mounted on the submount, a lens unit joined to the optical bench, and an optical path separator which separates light that is emitted from the light source and proceeds to the lens unit from light that is incident from the lens unit, wherein the submount is soldered to the optical bench.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic perspective view of an optical pickup apparatus according to an exemplary embodiment of the present invention;

FIG. 2 is a side view of the optical pickup apparatus shown in FIG. 1;

FIG. 3 is a perspective view of an optical bench of the optical pickup apparatus shown in FIG. 1; and

FIG. 4 is a schematic side view illustrating a combination relationship between a submount having a light source and an optical bench in an optical pickup apparatus, according to an exemplary embodiment of the present invention.

### DETAILED DESCRIPTION OF THE EXEMPLARY EMBODIMENTS OF THE PRESENT INVENTION

Reference will now be made in detail to the exemplary embodiments of the present invention, examples of which are illustrated in the accompanying drawings, wherein like reference numerals refer to the like elements throughout.

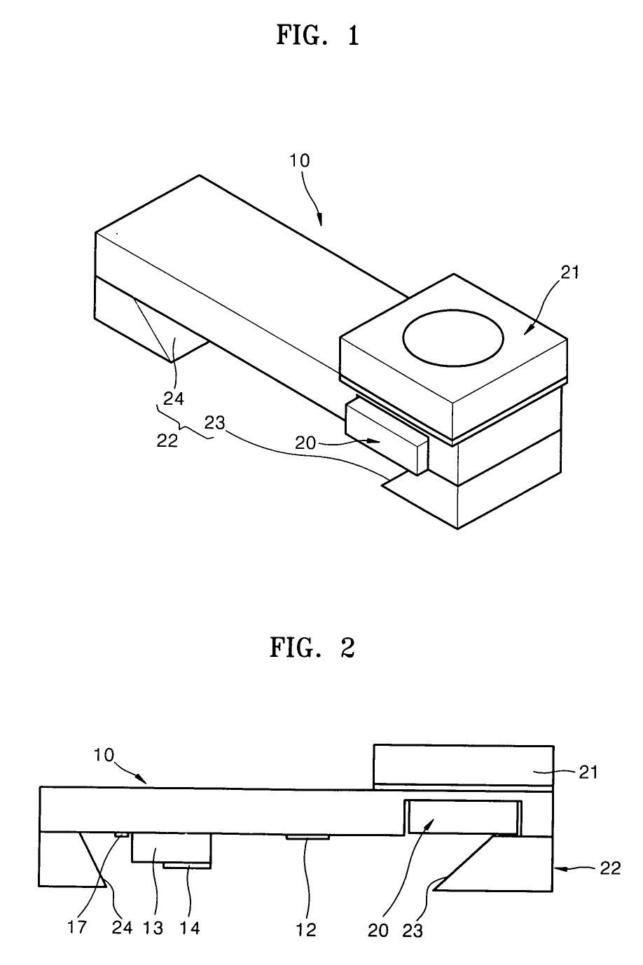

Referring to FIGS. 1 through 3, an optical pickup apparatus according to an exemplary embodiment of the present invention includes a light source 14, a submount 13 on which the light source 14 is mounted, an optical bench 10 at which a photodetector is disposed, a lens unit 21 and an optical path forming unit 22 that are combined with the optical bench 10, and an optical path separator 20 separating light that is emitted from the light source 14 and then proceeds to the lens unit 21 from light that is reflected from a data storage medium and then incident on the lens unit 21. The photodetector may include a main photodetector 17 and a monitor photodetector 12 that are disposed on the optical bench 10 to directly receive a part of the light emitted from the light source 14.

The optical bench 10 may be a SiOB and may include the light source 14, the submount 13, the lens unit 21, the optical path forming unit 22, and the optical path separator 20. The optical bench 10 may be manufactured, for example, by performing a microelectromechanical system (MEMS) process on an optical bench wafer.

A semiconductor laser emitting light having a predetermined wavelength may be used as the light source 14. For example, a semiconductor laser emitting light having a blue wavelength, e.g., a wavelength of 405 nm, may be used as the light source 14. In this case, the optical pickup apparatus can be used to record information on and reproduce information from a blue-ray disc (BD) or an advanced optical disc (AOD). As another example, a semiconductor laser emitting light having a red wavelength, e.g., a wavelength of 650 nm, may be used as the light source 14. In this case, the optical pickup apparatus can be used to record information onto and reproduce information from a DVD.

The light source 14 may be designed to emit light having a wavelength other than those of the foresaid examples. Furthermore, the light source 14 may be designed to emit light having different wavelengths so that the optical pickup apparatus is compatible with various types of optical data storage media having different formats. The wavelength of the light source 14 may vary with a data storage medium to which the optical pickup apparatus is applied. Accordingly, the optical pickup apparatus can be used with various types of optical data storage media, e.g., optical discs in the CD family, optical discs in the DVD family, BDs, and AODs.

For the light source 14, an edge-emitting semiconductor laser that emits a laser beam in a side direction of a semiconductor material layer may be used. In this case, considering such a light emitting structure, the light source 14 is mounted on the submount 13. As a result, the light source 14 is separated from a bottom surface 11 of the optical bench 10.

The light source 14 may be mounted on the submount 13 first and then installed on the optical bench 10. Alternatively, the submount 13 may be formed to protrude from the bottom surface 11 of the optical bench 10 and then the light source 14 may be mounted on the submount 13. The light source 14, if a semiconductor laser, may be directly formed on an optical bench wafer on which semiconductor processes are performed to manufacture the optical bench 10.

In an exemplary embodiment of the present invention, the submount 13 is installed on the optical bench 10 by means of soldering, which will be described below with reference to FIG. 4.

The lens unit 21 may be joined onto one side of a top surface of the optical bench 10. The lens unit 21 may include at least one of a refractive lens and a diffractive lens.

The optical path forming unit 22 includes a first mirror 23 which changes the direction of light incident from the light source 14 toward the lens unit 21 and a second mirror 24 which changes the direction of light that is incident to the first mirror 23 from the lens unit 21 and then reflected from the first mirror 23 toward the main photodetector 17.

The main photodetector 17 receives light reflected from a data storage medium and detects a data reproducing signal (e.g., a radio frequency (RF) signal) and at least one error signal (e.g., a focus error signal, a tracking error signal, and/or a tilt error signal) used for servo driving. The main photodetector 17 may be positioned on the bottom surface 11 of the optical bench 10.

The monitor photodetector 12 monitors the amount of light emitted from the light source 14. The monitor photodetector 12 may be positioned in front of the light source 14 such that a part of the light emitted from the light source 14 is directly incident onto the monitor photodetector 12 without passing through a reflecting mirror or the like.

The optical path separator 20 separates light that is emitted from the light source 14 and then proceeds to the lens unit 21 from light that is incident from the lens unit 21.

The optical bench 10 is provided with an installation recess 15 having an opening 16 so that the optical path separator 20 is inserted into the installation recess 15. Alternatively, without using the installation recess 15, the optical path separator 20 may be attached to one side of the optical bench 10. As another alternative, the optical path separator 20 may be integrally formed with the lens unit 21. Regardless of the presence or absence of the installation recess 15, it is preferable that the opening 16 is provided in the optical bench 10 to transmit light such that the light reflected from the first mirror 23 after being emitted from the light source 14 proceeds to the lens unit 21.

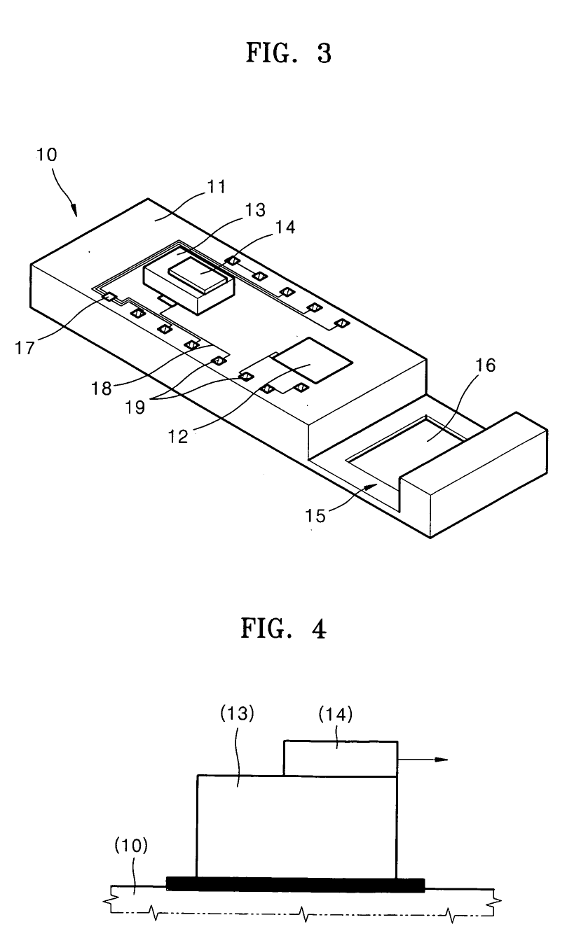

Referring to FIG. 3, wiring 18 and pads 19 are disposed on the bottom surface 11 of the optical bench 10 to electrically connect the light source 14, the main photodetector 17, and the monitor photodetector 12 to an external circuit. The pads 19 are used for electrical contact with the external circuit. When the main photodetector 17 and the monitor photodetector 12 are directly generated on a wafer for the optical bench 10, the wiring 18 and the pads 19 are formed on the optical bench 10 using, for example, a thin film process.

An actuator (not shown) which drives an integrated optical pickup and/or a radiating structure (not shown) which radiates heat generated in the light source 14 may be installed on the top surface of the optical bench 10. Another radiating structure may be further installed elsewhere on the optical bench 10 as needed.

FIG. 4 is a schematic side view illustrating a combination relationship between the submount 13 having the light source 14 and the optical bench 10 in an optical pickup apparatus according to an exemplary embodiment of the present invention. The optical pickup apparatus includes the optical bench 10 and the submount 13 that has the light source 14 thereon and is installed on the optical bench 10.

According to an exemplary embodiment of the present invention, the submount 13 is joined onto the optical bench 10 by means of soldering. In detail, after the submount 13 is placed on the optical bench 10, the submount 13 is soldered to the optical bench 10. When the submount 13 is joined to the optical bench 10 by means of soldering, the submount 13 can be installed so as to be parallel with the optical bench 10 without slanting. Accordingly, the light source 14 mounted on the submount 13 is installed so as to be parallel with the optical bench 10, such that light emitted from the light source 14 can proceed along an optical path formed by optical elements including the optical path forming unit 22 provided on the optical bench 10, without adjustment of the optical elements. Meanwhile, the soldering of the submount 13 to the optical bench 10 is simpler than a conventional process using an epoxy resin. As a result, manufacturing time and cost are reduced.

The light source 14 may be mounted on the submount 13 before or after the submount 13 is soldered to the optical bench 10.

According to this exemplary embodiment of the present invention, a submount is soldered to an optical bench so that the submount and a light source mounted thereon are installed so as to be parallel with the optical bench. As a result, light emitted from the light source can proceed along an optical path formed by optical elements including an optical path forming unit provided on the optical bench, without adjustment of the optical elements. Additionally, a process of combining the submount and the optical bench using soldering is simple, and therefore, manufacturing time and cost can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An optical pickup apparatus comprising:
an optical bench;
a submount installed on the optical bench;
a light source mounted on the submount;
a lens unit joined to the optical bench; and
an optical path separator which separates light that is emitted from the light source and then proceeds to the lens unit from light that is incident from the lens unit,
wherein the submount is soldered to the optical bench.

2. The optical pickup apparatus of claim 1, further comprising a photodetector installed on the optical bench to receive light.

3. The optical pickup apparatus of claim 2, further comprising an optical path forming unit comprising a first mirror which changes a direction of light incident from the light source toward the lens unit and a second mirror which changes a direction of light reflected from the first mirror after being output from the lens unit toward the photodetector.

4. The optical pickup apparatus of claim 1, wherein the optical bench comprises an installation recess into which the optical path separator is inserted.

5. The optical pickup apparatus of claim 1, wherein the optical path separator is integrally formed with the lens unit.

6. The optical pickup apparatus of claim 1, wherein the lens unit includes at least one of a refractive lens and a diffractive lens.

7. A method of combining a submount and an optical bench of an optical pickup apparatus which includes the optical bench, the submount installed on the optical bench, a light source mounted on the submount, a lens unit joined to the optical bench, and an optical path separator which separates light that is emitted from the light source and then proceeds to the lens unit from light that is incident from the lens unit, the method comprising:
placing the submount on the optical bench; and
soldering the submount to the optical bench.

8. The method of claim 7, further comprising, prior to the placing the submount on the optical bench, mounting the light source on the submount.

9. The method of claim 7, further comprising, after the soldering the submount to the optical bench, mounting the light source on the submount.
